(19) United States
(12) Patent Application Publication
(10) Pub. No.: US 2019/0009613 A1
(43) Pub. Date: Jan. 10, 2019

(54) NON-PNEUMATIC TIRE

(71) Applicant: Compagnie Generale des Etablissements Michelin, Clermont-Ferrand (FR)

(72) Inventors: Steven M CRON, Simpsonville, SC (US); Damon Lee CHRISTENBURY, Greenville, SC (US); Ryan Michael GAYLO, Simpsonville, SC (US); Timothy Brett RHYNE, Greenville, SC (US)

(73) Assignee: Compagnie Generale des Establissements Michelin, Clermont-Ferrand (FR)

(21) Appl. No.: 16/067,603

(22) PCT Filed: Dec. 31, 2016
(86) PCT No.: PCT/US16/69637

§ 371 Date: Jun. 30, 2018

Related U.S. Application Data
(60) Provisional application No. 62/274,140, filed on Dec. 31, 2015.

(51) Int. Cl. B60B 9/26; B60C 7/18

(52) U.S. Cl. CPC B60B 9/26; B60C 2007/146; B60C 7/18

(57) ABSTRACT

A non-pneumatic tire having a nesting high modulus spoke structure each spoke pretension such that the spokes maintain positive tension during operation of the wheel under normal operating loading conditions over a smooth surface.

### FIELD

The subject matter relates to a non-pneumatic tire having a nesting spoke and each spoke having a pretension such that the spokes maintain positive tension during operation of the wheel under normal operating loading conditions over a smooth surface.

### BACKGROUND

The details and benefits of non-pneumatic wheels are described e.g., in U.S. Pat. Nos. 6,769,465; 6,994,134; 7,013,939; and 7,201,194, herein incorporated by reference in their entirety. Some non-pneumatic tire constructions incorporate a shear band, embodiments of which are described in e.g., U.S. Pat. Nos. 6,769,465 and 7,201,194, herein incorporated by reference in their entirety. Such non-pneumatic tires provide advantages in tire performance without relying upon a gas inflation pressure for support of the loads applied to the tire.

In one example of a non-pneumatic wheel, a compliant band with a ground contacting portion can be connected with a plurality of tension-transmitting, web-like elements (also referred to as “spokes”) extending radially from a center element or hub. By way of example, such non-pneumatic wheel may be formed by open cast molding in which a material such as e.g., polyurethane is poured into a mold that forms all or part of the non-pneumatic tire. Alternatively the spokes may be formed individually then attached to the outer band and hub.

Tension of the spokes is countered by circumferential compression in the outer band of the wheel. The greater the tension of the spokes, the greater the circumferential compression. Uniform spoke tension be created by a uniform pull of each of the spokes. When the wheel is placed under load, such as when it is supporting weight of a vehicle, a portion of the load is carried through circumferential compression forces in the outer band in the circumferential direction to the top of the outer band. The spokes at the top of the wheel carry a larger amount of tension which is proportional to the load applied to the wheel. This load carrying mechanism is similar to how the radial cords of a pneumatic tire carry the load of the vehicle on the top of the rim and is generally referred to as a “top loading wheels.”

Bottom loading wheels, such as solid tires, semi-solid tires, foam filled tires or spring wheels, carry a predominant portion of the load in compression against the hub of the wheel.

When a tire encounters an obstacle, such as may be encountered by a tire rolling over a surface that is not smooth or when encountering an obstacle, such as a rock, crack, pothole, or curb, the outer band is momentarily displaced and momentarily deforming the spokes beyond the amount of deformation due to deflection of the outer band in the contact patch. If the spokes have a high stiffness rate, the deformation caused by the obstacle creates a larger load transmitted to the vehicle than if the spokes have a low stiffness rate. The momentary high load created by the obstacle is perceived by the vehicle, and the operator thereof, as noise, vibration, shock, and or impulse, herein referred to as “intrusivity” with increasing intrusivity being associated with increasing noise, and or vibration etc.

Generally, spoke stiffness increases as the spoke is extended. The slope of the stiffness of the spoke compared to the displacement of the spoke will indicate the wheels response to momentary displacements from encountering an obstacle. The greater the slope, the greater the force created as the spoke is displaced while the spoke having a smaller stiffness-displacement slope will exert less force to the vehicle when the tire encounters a momentary displacement.

Spokes constructed of a high modulus material will be stiffer than spokes having a low modulus material. Construction of spokes in traditional non-pneumatic tires from a low modulus material creates non-pneumatic tire spokes having the ability to absorb shock, vibration and reduce noise and impulse forces. Construction of spokes in traditional non-pneumatic tires from high modulus materials creates non-pneumatic tire spokes having stiffer response and a generally higher intrusively.

Using materials having a low modulus to create non-pneumatic tires having low intrusivity require spokes having an actual length which is close to the effective length of the spoke such that the spokes of the tire are stretched to achieve the appropriate stiffness rate. To reduce the intrusively of the tire, the spokes may be lengthened by lengthening the effective length until the stiffness rate desired is achieved. The effective length, however, is limited by the distance between the hub and the outer band, and in effect is a limiting factor the reduction of intrusivity in the design of a non-pneumatic tire. Complicating the design of the spokes is that while a minimum stiffness is needed in the spokes to support the weight of the vehicle, the stiffness rate of change for the loaded tire increases quickly as the spokes are stretched to support the load. This results in spokes that, although are designed to have a low stiffness, when loaded, have a high stiffness rate, particularly when accommodating larger momentary displacements.

Accordingly, a spoke structure that is has a stiffness rate that is sufficiently low to reduce noise, vibration and impulses would be useful. A spoke structure that avoids large localized spoke deformations would also be useful. A spoke structure that also minimizes the effective length needed to achieve a reduction of noise, vibration, shock and or impulses would be particularly helpful.

### SUMMARY

Aspects and advantages will be set forth in part in the following description, or may be obvious from the description, or may be learned through practice.

In one exemplary embodiment, a non-pneumatic wheel having a plurality of spokes, each spoke displaced to create pretension, the displacement equal to or greater than the deflection of the tire's contact patch when loaded under normal operating conditions.

In one exemplary embodiment, a non-pneumatic wheel having a plurality of spokes, each spoke displaced to create pretension, the displacement equal to or greater than the deflection of the tire's contact patch when loaded under normal operating conditions to its maximum operating design capacity. The maximum operating design capacity as indicated by the manufacturer.

In one exemplary embodiment, a non-pneumatic wheel having a plurality of spokes, each spoke displaced to create pretension, the displacement equal to or greater than the deflection of the tire's contact patch when loaded under normal operating conditions. The spokes having a v-shaped geometry with a connection to the outer band located radially out from the connection with the wheel hub.

In one exemplary embodiment, a non-pneumatic wheel having a plurality of spokes, each spoke displaced to create pretension, the displacement equal to or greater than the deflection of the tire's contact patch when loaded under normal operating conditions. The spokes having a v-shaped geometry such that each spoke has a nearly linear stiffness when deflected radially over a distance approximately equal to the tires vertical deflection.

In one exemplary embodiment, a non-pneumatic wheel having a plurality of spokes, each spoke displaced to create pretension, the displacement equal to or greater than the deflection of the tire's contact patch when loaded under normal operating conditions. The spokes having a v-shaped geometry such that each spoke has a nearly linear stiffness when deflected radially over a distance approximately equal to the tires vertical deflection. Each spoke nesting with the adjacent spoke such that the nose of the spoke extends past a vertical line drawn between the connection point of the adjacent spoke with the hub and the connection point of the adjacent spoke with the outer band.

These and other features, aspects and advantages will become better understood with reference to the following description and appended claims. The accompanying drawings, which are incorporated in and constitute a part of this specification, illustrate embodiments and, together with the description, serve to explain the principles of the invention.

### BRIEF DESCRIPTION OF THE DRAWINGS

A full and enabling disclosure, including the best mode thereof, directed to one of ordinary skill in the art, is set forth in the specification, which makes reference to the appended figures, in which:

FIG. 1 provides a side view of an embodiment of the outer portion of non-pneumatic tire having a high degree of spoke curvature.

FIG. 2 provides a partial enlarged side view of the outer portion of the non-pneumatic tire with the spokes in a relaxed neutral state.

FIG. 3 provides a partial enlarged side view of the outer portion of the non-pneumatic tire with the spokes in a tensioned state as they would be when connected to the hub portion of the tire.

FIG. 4 provides an enlarged partial perspective view of a single spoke, fastener assembly and a portion of the hub of an embodiment of the non-pneumatic tire.

FIG. 5 provides an enlarged partial perspective view of a single spoke, fastener assembly and a portion of the hub of an embodiment of the non-pneumatic tire.

The use of identical or similar reference numerals in different figures denotes identical or similar features.

### DETAILED DESCRIPTION

The present disclosure provides a pretensioned spoke non-pneumatic wheel. For purposes of describing embodiments, reference now will be made in detail to embodiments and/or methods, one or more examples of which are illustrated in or with the drawings. Each example is provided by way of explanation, not limitation of the invention. In fact, it will be apparent to those skilled in the art that various modifications and variations can be made in the present embodiments without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The following terms are defined as follows for this disclosure:

“Axial direction” or the letter “A” in the figures refers to a direction parallel to the axis of rotation of for example, the shear band, tire, and/or wheel as it travels along a road surface.

“Radial direction” or the letter “R” in the figures refers to a direction that is orthogonal to the axial direction and extends in the same direction as any radius that extends orthogonally from the axial direction.

“Equatorial plane” means a plane that passes perpendicular to the axis of rotation and bisects the shear band and/or wheel structure.

“Radial plane” means a plane that passes perpendicular to the equatorial plane and through the axis of rotation of the wheel.

“Delta stiffness” means the slope of the line drawn on a plot of force over displacement, with the slope measured from a position where the object is unstressed and exerting no force, to the position where the object is exerting the force from which the stiffness is calculated by dividing the force by the displacement.

“Tangent stiffness” means the slope of the line drawn on a plot of force over displacement where the slope is measured by the change in force divided by the change in displacement. In other words, the tangent slope is the slope of a line that is drawn tangent to line drawn of a plot of force over displacement for the object at a given location on the force over displacement line.

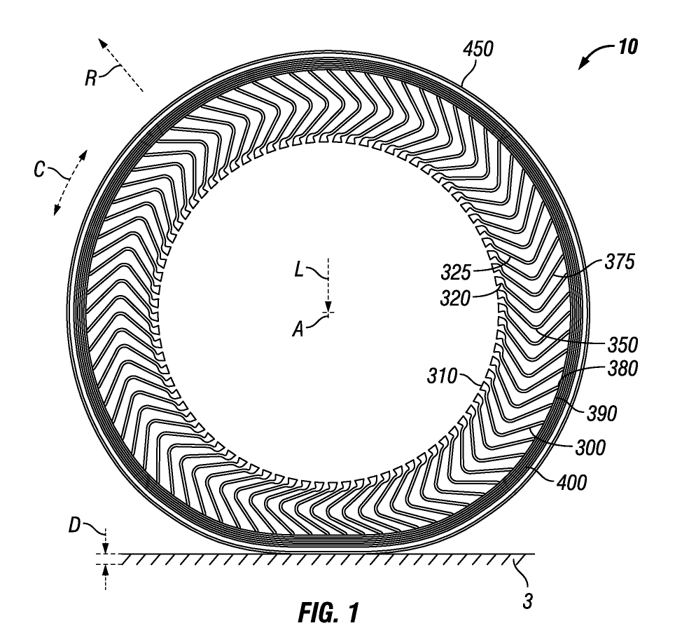

FIG. 1 provides a side view of an embodiment of the outer portion of non-pneumatic tire having a high degree of spoke curvature. The wheel 10 shown here is resting on a surface 3. A load L is applied to the hub of the wheel, which could represent the weight, or a portion thereof, of the vehicle. When the load L is applied, the tire is pressed against the surface 3 and deflects a distance D. The area of contact is referred to as the “contact patch” and provides an area over which the tire interfaces and reacts with the surface on which it travels.

When viewed from the axial side of the wheel, the spoke 300 possess a V-shaped geometry. The geometry allows for a nearly linear stiffness when deflected radially over a distance approximately equal to the tire's vertical deflection D which results in comparatively lower force transmission through the wheel during a dynamic loading event, such as when the wheel 10 encounters an obstacle such as a crack, rock or curb in the surface 3 such as might be found in a road, than with non-pneumatic tires having spokes possessing less curvature.

The V-shaped geometry of the spoke begins at the attachment point 380 of the spoke to the outer band 400. A radially outer portion 375 of the spoke 300 extends radially inward and circumferentially in a clockwise direction. The spoke then curves forming a radiused nose 350. The radially inner portion 325 continues in a radially inward and circumferentially in a counter-clockwise direction to hub attachment point 320 which possesses a dovetail thickened portion 310 for engagement a fastener.

The spoke's V-shaped geometry allows the spoke 300 to nest with each adjacent spoke 300 on either side of it, preventing the spokes from clashing into each other during normal operating conditions, such as rolling under the intended design loading conditions for the tire. The nesting enables the nose of the spoke to extend circumferentially past a straight line drawn between the connection point of an adjacent spoke with the hub and the connection point of the adjacent spoke with the outer band.

In the embodiment shown here, the spokes 300 are integrally formed with an outer ring 390 which is attached to the outer band 400. Alternatively the spokes may be formed individually and bonded individually with the outer band 400.

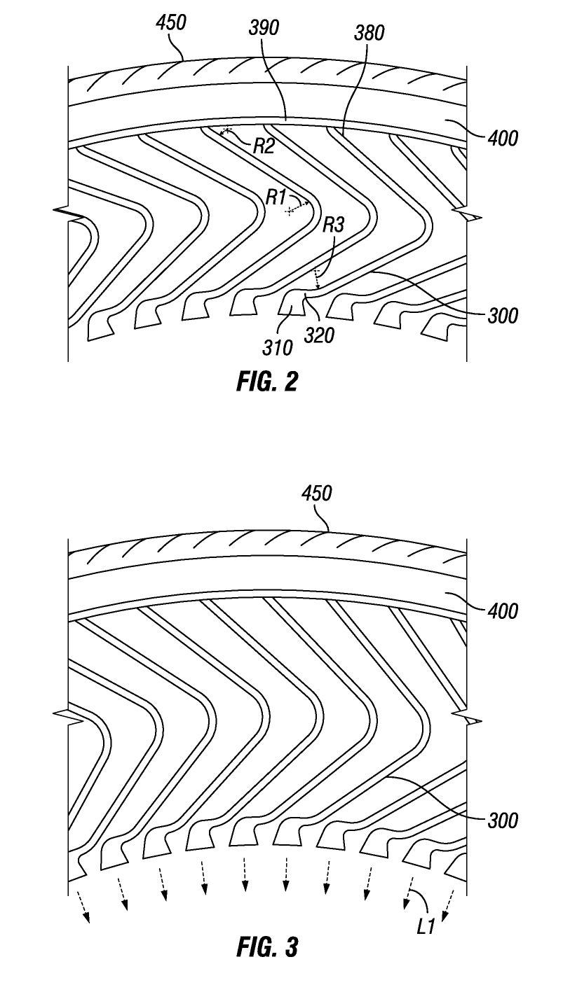

FIG. 2 provides a partial enlarged side view of the outer portion of the non-pneumatic tire 10 with the spokes 300 in a relaxed neutral state. The outer band 400 of the tire possess a tread 450. The relaxed neutral state is the position that the spokes would assume when they are disconnected from the hub, or in other words, when the spokes have no pretention applied to the spokes. The spokes possess a dovetail portion 310 at the radially inner portion of the spoke. The radially inner portion of the spoke extends out in a circumferential direction from the dovetail 310 at the connection point 320 with the dovetail. The spoke extends to a nose portion 350 which possess a radius R1. The radius R1 reduces bending stresses as compared to a sharp v-shaped nose. The spoke then extends from the nose portion 350 to the radially outer connection point 380 which then, after another radiused bend R2, joins to the outer ring 390 which is attached with the outer band 400

FIG. 3 provides a partial enlarged side view of the outer portion of the non-pneumatic tire with the spokes 300 in a tensioned state as they would be when connected to the hub portion of the tire. Here a force L1 is applied to the radially inner end of the spokes 300 extending the spokes radially inward toward the central axis of the wheel 10. When the spoke 300 is attached to the hub 100, the radial displacement of the spoke creates the pretension L1. The radial displacement due to pretension should be greater than the amount of deflection the tire undergoes during normal operation in the contact patch. It is anticipated, however, that a dynamic loading event may cause the spoke to momentarily compress past its neutral state.

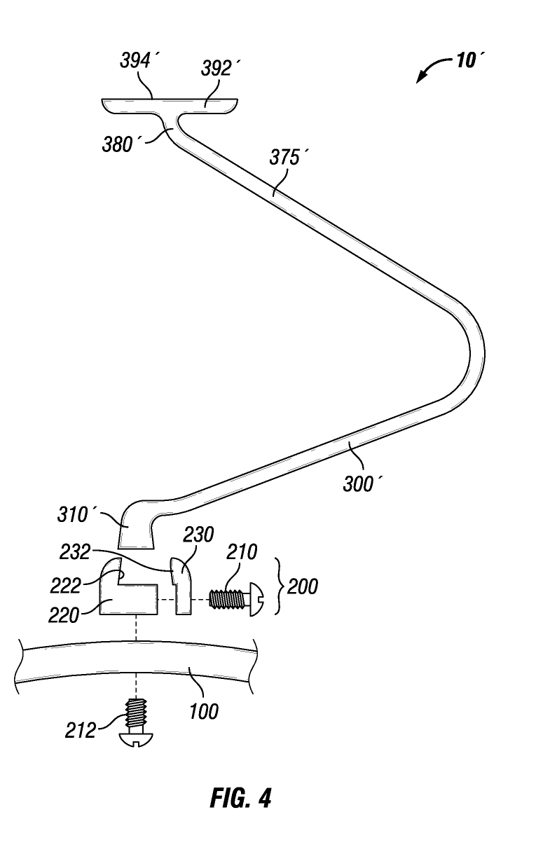

FIG. 4 provides an enlarged partial perspective view of an alternative embodiment of a single spoke 300′, fastener assembly 200 and a portion of the hub 100 of an embodiment of a non-pneumatic tire 10′. Here the hub 100 is shown attached to the spoke 300′ by a fastener assembly 200. The fastener assembly creates a slot which clamps on to the dovetail portion 310′ of the spoke. The fastener assembly 200 includes an L-shaped bracket 220, a bracket plate 230 and at least one faster 210. Here a plurality of screw fasteners 210 retain the bracket plate 230 onto the L-shaped bracket 220 which impinge the dovetail portion 310′ of the spoke 300′ by clamping it with the inner surfaces 222, 232 of the bracket.

The radially outer portion 375′ of the spoke 300′ possesses a T-shaped radially outer end 392′ which provides a surface 394′ that is attached to the outer band 400. In the embodiment shown, the radially outer surface 394′ of the spoke 300′ is bonded with an adhesive chosen depending upon the materials used for the outer band and spoke 300′.

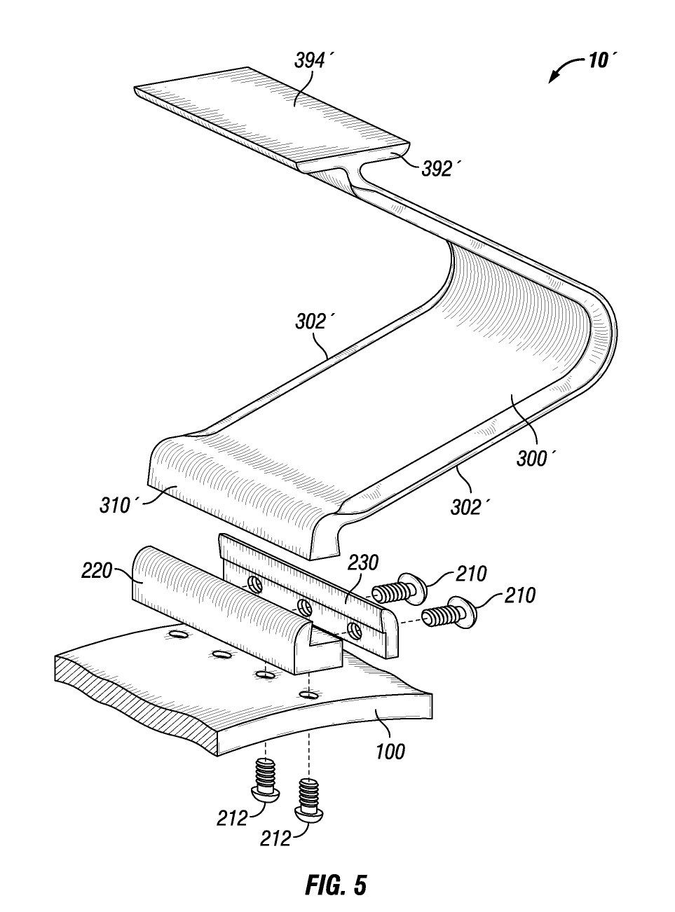

FIG. 5 provides an enlarged partial perspective view of the single spoke 300′, fastener assembly 200 and a portion of the hub 100 of the embodiment of the non-pneumatic tire 10′. A plurality of fasteners 212 retain the L-shaped bracket 220 to the hub 100. Likewise, a plurality of fasteners 210 retain the bracket plate 230 to the L-shaped bracket 220 and provide impinging force to retain the thickened radially inner end 310′ of the spoke 300′. Alternative embodiments, not shown, may possess thickened shapes other than a dovetail or triangular shape as shown for the thickened radially inner end 310′, such as a circular shape or rectangular shape. Alternative embodiments may also retain the spoke by sliding the thickened radially inner end 310′ of the spoke into a corresponding slot in the hub, the slot being appropriately sized to accommodate and retain the thickened radially inner end of the spoke 300′.

The low spring rate of the spoke, and high pretension are allow for a tangent stiffness that is lower than the tangent stiffness of a similarly sized non-pneumatic tire constructed with spokes which possess less curvature. Here, the circumferentially elongated spoke curvature allows the outer band to displace vertically over a greater distance without generating as great of a reaction force in the spokes at the top of the wheel than would occur if the spokes were shorter. In the embodiments shown, the spokes have a circumferential length, as measured from the circumferential distance from a line drawn between the connection to the hub and connection to the outer band to the front of the nose of the spoke which is at least 75 percent of that of the distance of the uncompressed height of the spoke, the uncompressed height being measured between the connection point to the hub and the connection to the outer band of the spoke in a neutral, unloaded, state. In the embodiment shown in FIGS. 4 and 5, the circumferential length is at least 80% of that of the uncompressed height of the spoke. When pulled into tension, the circumferential length of the spoke is at least 25% that of the tensioned height, when pretension is applied.

Surprisingly increasing the modulus of a spoke material allows the creation of a spoke having a lower, and nearly linear, tangent spring stiffness. This is accomplished in part by applying a pretention to the spokes such that the displacement of the spokes from a neutral position is equal to or greater than the displacement of the tire's contact patch. The pretension also maintains the top loading nature of the wheel, allowing the wheel to carry the load by the spokes in tension unlike previously attempts at bottom loading spring wheels.

By creating the spokes individually, such as shown in the spoke embodiment 300′ above, the spokes may be injection molded economically from a variety of alternative materials such as thermoplastic. The material chosen should have a modulus in the range of 1,000 MPa to 3,000 MPa for the embodiments shown. In the particular embodiments shown above in FIG. 4 and FIG. 5 a material having a modulus of 1,200 MPa was found to produce satisfactory results.

It should be understood that other web element configurations and geometries may be used within the scope of the invention.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

We claim:

1. A non-pneumatic wheel having a deflection of the outer band in contact patch the under normal loading conditions, the non-pneumatic wheel defining an axis of rotation and defining axial, radial, and circumferential directions, the non-pneumatic wheel comprising:
an outer band, the outer surface of the outer band having a ground contacting surface;
a hub; and
a plurality of spokes wherein each spoke is displaced to create pretension in the radial direction, the displacement equal to or greater than the predetermined deflection of the outer band.

2. The non-pneumatic wheel of claim 1 wherein the plurality of spokes each possess a v-shaped geometry.

3. The non-pneumatic wheel of claim 2 wherein each of the plurality of spoke nests with the adjacent spoke.

4. The non-pneumatic wheel of claim 2 wherein each of the plurality of spoke nests with the adjacent spoke such that the nose of the spoke extends past a vertical line drawn between the connection point of the adjacent spoke with the hub and the connection point of the adjacent spoke with the outer band.

5. The non-pneumatic wheel of claim 4 wherein said plurality of spokes have a nearly linear stiffness through displacement experienced under normal loading conditions of the wheel.

6. A non-pneumatic wheel of claim 1 wherein the normal loading condition is predetermined by the manufacturer.

7. A non-pneumatic wheel of claim 1 wherein the normal loading condition is indicated on the non-pneumatic wheel.

8. A non-pneumatic wheel of claim 1 wherein the displacement of the spoke is the displacement measured between the neutral state of the spoke and the state where the plurality of spokes are attached to the hub and the outer band with the wheel not subject to a load.

9. A non-pneumatic wheel of claim 8 wherein the neutral state of the spoke is the shape the spoke assumes when it is detached from the hub and the outer band.

10. A non-pneumatic wheel of claim 1 wherein the deflection of the outer band is a measurement of the difference between a first length between the axis of rotation of the wheel and a point on outer band in an unloaded state and a second length between the axis of rotation of the wheel and the point on outer band in a loaded state.

11. A non-pneumatic wheel of claim 10 wherein the deflection of the spoke is measured at the midpoint of the contact patch.

12. A non-pneumatic wheel of claim 1 wherein each of the plurality of spokes have a circumferential length which is at least 75 percent of that of the distance of the uncompressed height of the spoke.

13. A non-pneumatic wheel of claim 1 wherein the plurality of spokes is constructed from a high modulus material.

14. A non-pneumatic wheel having a plurality of spokes attached to an outer band, each spoke displaced to create a pretension, the displacement equal to or greater than a deflection of the outer band of the wheel that occurs in the contact patch when loaded under normal operating conditions.

15. A non-pneumatic wheel having a plurality of spokes, each spoke displaced to create pretension, the displacement equal to or greater than a vertical deflection of the spokes in the contact patch of the wheel when loaded under normal operating conditions; the spokes having a v-shaped geometry such that each spoke has a nearly linear stiffness when deflected radially over a distance approximately equal to the vertical deflection of the wheel.

16. The non-pneumatic wheel of claim 14 wherein the plurality of spokes each possess a v-shaped geometry.

17. The non-pneumatic wheel of claim 16 wherein each of the plurality of spoke nests with the adjacent spoke.

18. The non-pneumatic wheel of claim 17 wherein each of the plurality of spoke nests with the adjacent spoke such that the nose of the spoke extends past a vertical line drawn between the connection point of the adjacent spoke with the hub and the connection point of the adjacent spoke with the outer band.

19. The non-pneumatic wheel of claim 18 wherein said plurality of spokes have a nearly linear stiffness through displacement experienced under normal loading conditions of the wheel.

20. A non-pneumatic wheel of claim 14 wherein the normal loading condition is the maximum load indicated on the non-pneumatic wheel.
